(19) United States
(12) Patent Application Publication
(10) Pub. No.: US 2010/0058118 A1
(43) Pub. Date: Mar. 4, 2010

(54) STORAGE MEDIUM RECORDING INFORMATION REACQUISITION PROCEDURE GENERATION PROGRAM AND INFORMATION REACQUISITION PROCEDURE GENERATION APPARATUS

(75) Inventor: Yuji YAMAOKA, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/550,115

(22) Filed: Aug. 28, 2009

(30) Foreign Application Priority Data
Aug. 29, 2008 (JP) 2008-221440

(51) Int. Cl. G06F 15/16; G06F 11/07

(52) U.S. Cl. 714/48; 709/203; 714/E11.024

(57) ABSTRACT

A storage medium recording an information reacquisition procedure generation program causing a computer to execute a process of generating a reacquisition procedure for reacquiring information, the information reacquisition procedure generation program causing the computer to execute a method comprising: reading a message history from a storage unit storing the message history recording a series of messages exchanged to and from a device providing information until the information is provided; generating a message transitional relationship with respect to the information by extracting a parent-child relationship between the respective messages contained in the series of messages based on the series of messages until the information contained in the read message history is acquired as well as by combining the same or similar messages of the series of messages into one; and outputting the reacquisition procedure with respect to the information based on the generated transitional relationship.

### CROSS-REFERENCE TO RELATED APPLICATIONS

This application is based upon and claims the benefit of priority from the prior Japanese Patent Application No. 2008-221440 filed on Aug. 29, 2008, the entire contents of which are incorporated herein by reference.

### FIELD

The present invention relates to a storage medium recording an information reacquisition procedure generation program and an information reacquisition procedure generation apparatus.

### BACKGROUND

A huge number of Web pages providing various kinds of information are open to the public on the World Wide Web (hereinafter referred to as “WWW”). In general, a search engine is used as a method for detecting a Web page providing desired information. Moreover, Web pages are associated with each other by links, and thus there is another method of following the links to find the desired Web page. A Web page detected in such a manner may contain information which is to be reacquired later. One of the simplest methods for meeting such a request includes a bookmark function of a Web browser. The bookmark function allows the URL (Uniform Resource Locator) of a frequently accessed Web site to be specified so as to be preliminarily stored. In response to a certain operation, the stored URL is read to reacquire the Web page from the Web site of the URL.

However, there are many Web pages which cannot be reacquired by such a simple information reacquisition procedure as the bookmark function. For example, there is a Web page to which access control is applied so as not to be acquired before authentication is performed by form-based authentication. In order to acquire such a Web page, some requests are required. However, the bookmark function may request a specific URL only once, and thus cannot reacquire the Web page.

In order to address this problem, there is provided an information reproduction method such that communication definition information is generated to sequentially reproduce the requests made by a user based on an operation history; and then, the communication definition information is used to sequentially send the requests to acquire the Web pages the user wants to reacquire. Note that a related technique is disclosed in Japanese Patent Laid-Open No. 2006-190033.

### SUMMARY

According to an aspect of the present invention, there is provided a storage medium recording an information reacquisition procedure generation program causing a computer to execute a process of generating a reacquisition procedure for reacquiring information, the information reacquisition procedure generation program causing the computer to execute a method including: reading a message history from a storage unit storing the message history recording a series of messages exchanged to and from a device providing information until the information is provided; generating a message transitional relationship with respect to the information by extracting a parent-child relationship between the respective messages contained in the series of messages based on the series of messages until the information contained in the read message history is acquired as well as by combining the same or similar messages of the series of messages into one; and outputting the reacquisition procedure with respect to the information based on the generated transitional relationship.

Additional objects and advantages of the invention will be set forth in part in the description which follows, and in part will be obvious from the description, or may be learned by practice of the invention. Objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 is a block diagram of an embodiment;

FIG. 2 is a block diagram of an information acquisition system in accordance with an embodiment;

FIG. 3 is a block diagram illustrating an example of a hardware configuration of an information reacquisition procedure generation apparatus;

FIG. 4A illustrates the first half of an example of a message history;

FIG. 4B illustrates the latter half of the example of the message history;

FIG. 5 is an example of a node information table;

FIG. 6 is an example of an edge information table;

FIG. 7 is an example of a tree display screen;

FIG. 8 is an example of a message classification modification screen;

FIG. 9 is an example of the tree display screen after the message classification is modified;

FIG. 10 is another example of the tree display screen after the message classification is modified;

FIG. 11 is an example of the tree display screen after a node is deleted;

FIG. 12 is an example of a parent node change screen;

FIG. 13 is an example of the tree display screen after a parent node is changed;

FIG. 14 is an example of a reacquisition program to be generated;

FIG. 15 is a flowchart showing a procedure for generating an information reacquisition program;

FIG. 16 is a flowchart showing a procedure for the tree structure generation process (node extraction process); and

FIG. 17 is a flowchart showing a procedure for a tree structure generation process (edge extraction process).

### DESCRIPTION OF EMBODIMENTS

For example, according to the information reacquisition procedure generation method for generating an information reacquisition procedure based on the operation history disclosed in Japanese Patent Laid-Open No. 2006-190033 described above, the procedure for reacquiring information to be defined reflects the procedure which the user really performed as is. For this reason, the information reacquisition procedure generation method has a problem in that the procedure for reacquiring information to be generated is not optimized.

For example, consider the case where there are four Web pages “A”, “B”, “C”, and “D”; and “A” is linked with “B”, “B” is linked with “C” and “B” is linked with “D”. In order to open the Web page “C” a request needs to be issued to the Web pages “A”, “B” and “C” in that order. Likewise, in order to open the Web page “D”, a request needs to be issued to the Web pages “A”, “B”, and “D” in that order. In this case, the shortest operation procedure for opening the Web page “D” is illustrated by arrows as “→A→B→D”. However, the user may not always follow the shortest operation procedure for calling up a web page. For example, if the user referred to the Web page “C” in the middle and then to “D” the operation history stores the procedure “→A→B→C→B→D”. In this case, the operation procedure for reacquiring “D” becomes “→A→B→C→B→D” based on the stored operation history.

As described above, the operation procedure obtained by the well-known technique is not optimized in consideration of the number of requests.

An object of the present invention is to provide an information reacquisition procedure generation program and an information reacquisition procedure generation apparatus capable of simplifying a user's operation for information reacquisition and generating an optimized information reacquisition procedure.

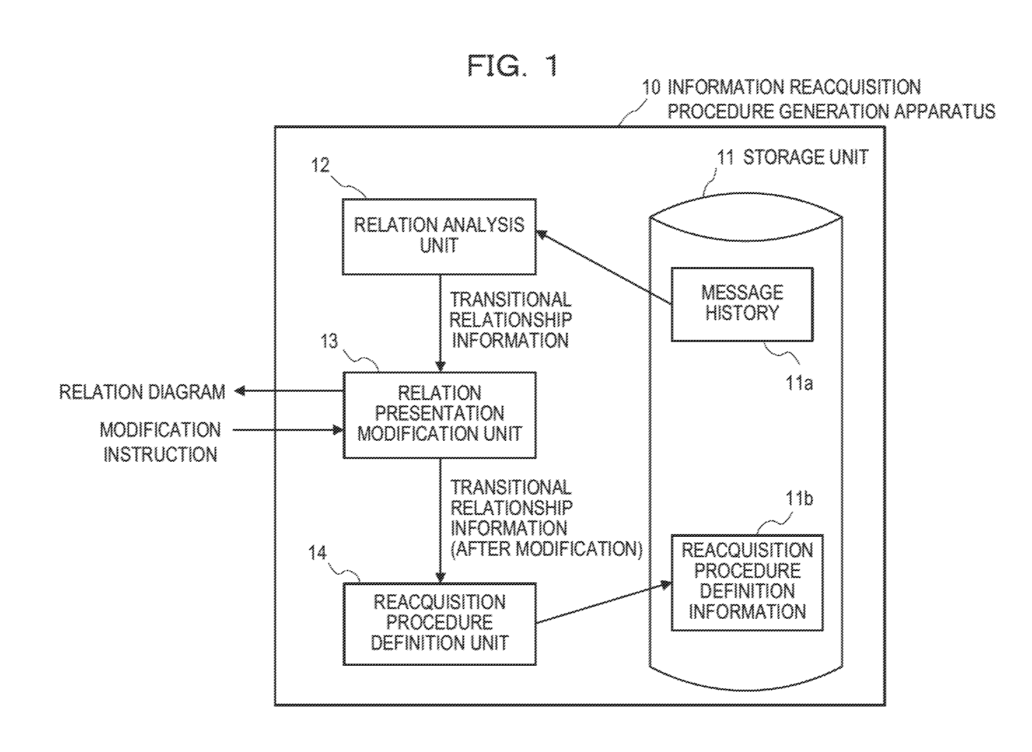

Hereinafter, embodiments will be described with reference to the accompanying drawings. FIG. 1 is a block diagram of an embodiment.

An information reacquisition procedure generation apparatus 10 includes a storage unit 11, a relation analysis unit 12, a relation presentation modification unit 13, and a reacquisition procedure definition unit 14.

The storage unit 11 includes a message history 11a and reacquisition procedure definition information 11b. The message history 11a records a series of messages exchanged between an information providing device and an information receiving client in chronological order until specific information is provided. The message includes a request for information by the client side and a response to this request by the information providing device. The reacquisition procedure definition information 11b includes a minimum message required to reacquire specific information generated by the reacquisition procedure definition unit 14 as well as a transmission order.

The relation analysis unit 12 reads the message history 11a stored in the storage unit 11 and analyzes an information transitional relationship based on the messages. The information transitional relationship may be represented, for example, as a tree structure with a message for calling specific information as a node and with a transitional relationship between the nodes as an edge. The node may be associated with information obtained by exchanging the messages to and from the information providing device. The information transitional relationship may be rephrased as a node (or message) transitional relationship.

The message history 11a records the operations performed by the user as is, but that information may not be acquired by an optimal procedure. However, when the user acquires the same or similar information, the message history 11a records the same or similar message. With that in mind, the relation analysis unit 12 analyzes the syntax of an individual message recorded in the message history 11a to extract specific data appearing commonly in the messages. Then, the relation analysis unit 12 uses the extracted specific data to combine the same or similar messages to generate a node. More specifically, the relation analysis unit 12 performs a syntactic analysis to extract the URL of the message, the request method, the response status code, and the like as specific data. Then, the relation analysis unit 12 uses the extracted specific data to classify the messages and assigns a node for each classification. Then, the relation analysis unit 12 sets one of the messages classified in the same node as a representative message to generate node information. Then, the relation analysis unit 12 uses the obtained node information to determine the node containing a message calling the representative message and sets the node to a parent node. Then, the relation analysis unit 12 combines the determined parent-child relationship between a parent node and a child node into edge information. Then, the relation analysis unit 12 generates transitional relationship information of a message represented as a tree structure with the same or similar message group as a node and with a transitional relationship between nodes as an edge. Then, the relation analysis unit 12 outputs the transitional relationship information to the relation presentation modification unit 13.

The relation presentation modification unit 13 acquires the transitional relationship information and presents the user with a relation diagram representing the message transitional relationship. Moreover, in response to a modification request (if any), the relation presentation modification unit 13 modifies the relation diagram and transitional relationship information. For example, the relation presentation modification unit 13 uses the node and the edge extracted by the relation analysis unit 12 to cause a display device to display the message transitional relationship as a relation diagram of a tree structure. The user can see the displayed relation diagram to confirm the message transitional relationship. If the user wants to change the message transitional relationship, the user may make a modification request. When the modification request is received from the user, the relation presentation modification unit 13 modifies the information transitional relationship based on the user's request and presents the user with a modified relation diagram again. Such a procedure is repeated to determine the message transitional relationship information represented as a tree structure.

The reacquisition procedure definition unit 14 uses the message transitional relationship information determined by the relation presentation modification unit 13 to determine the messages needed to reacquire specific information and to define a reacquisition procedure. For example, when the node transitional relationship is represented as a tree structure, the reacquisition procedure definition unit 14 follows the path reaching the node corresponding to the desired information and sequentially detects the parent node. Then, the reacquisition procedure definition unit 14 uses the representative message corresponding to the parent node to define the messages and the transmission order until reacquiring the desired information as a procedure and generates the reacquisition procedure definition information 11b. For example, the reacquisition procedure definition information 11b is generated in the form of an information reacquisition program to cause a computer to execute a process of reacquiring desired information.

According to the information reacquisition procedure generation apparatus 10 configured as above, the relation analysis unit 12 reads the message history 11a stored in the storage unit 11, analyzes the syntax of the recorded messages, and combines the same or similar message groups into a node. The relation analysis unit 12 sets the representative message for each node. Moreover, the relation analysis unit 12 detects the parent node for each node and extracts the node transitional relationship (tree structure) as an edge. In this manner, the message transitional relationship information represented as nodes and edges is generated. The relation presentation modification unit 13 uses the message transitional relationship information to present the user with a relation diagram representing the message transitional relationship as a tree structure. This allows the user to visually understand the message transitional relationship. If the user wants to make a modification, the user may make a modification request. When the modification request is received from the user, the relation presentation modification unit 13 modifies the message transitional relationship information based on the user's request and updates the relation diagram presented to the user. Then, the reacquisition procedure definition unit 14 uses the modified transitional relationship information to define the reacquisition procedure for reacquiring desired information and generates the reacquisition procedure definition information 11b. The reacquisition procedure definition information 11b may be generated in the form of a program to cause a computer to execute the processing procedure.

An information acquisition device makes a series of requests based on the reacquisition procedure definition thus generated to allow the user to automatically reacquire desired information. Alternatively, the processing program generated by the information acquisition device may be executed by a computer to allow the user to automatically reacquire desired information. This simplifies the operation of the user who wants to reacquire information. Note that the same or similar messages are combined into a node. The message transitional relationship is analyzed in units of nodes. Therefore, if the same or similar information is acquired repeatedly, the transitional relationship information is defined as a node transitional relationship. Thereby, the information reacquisition procedure generation apparatus 10 may provide an optimal procedure for acquiring desired information based on the transitional relationship information.

Hereinafter, an embodiment applying the present invention to the generation of a procedure for reacquiring a Web page will be described in detail with reference to the drawings.

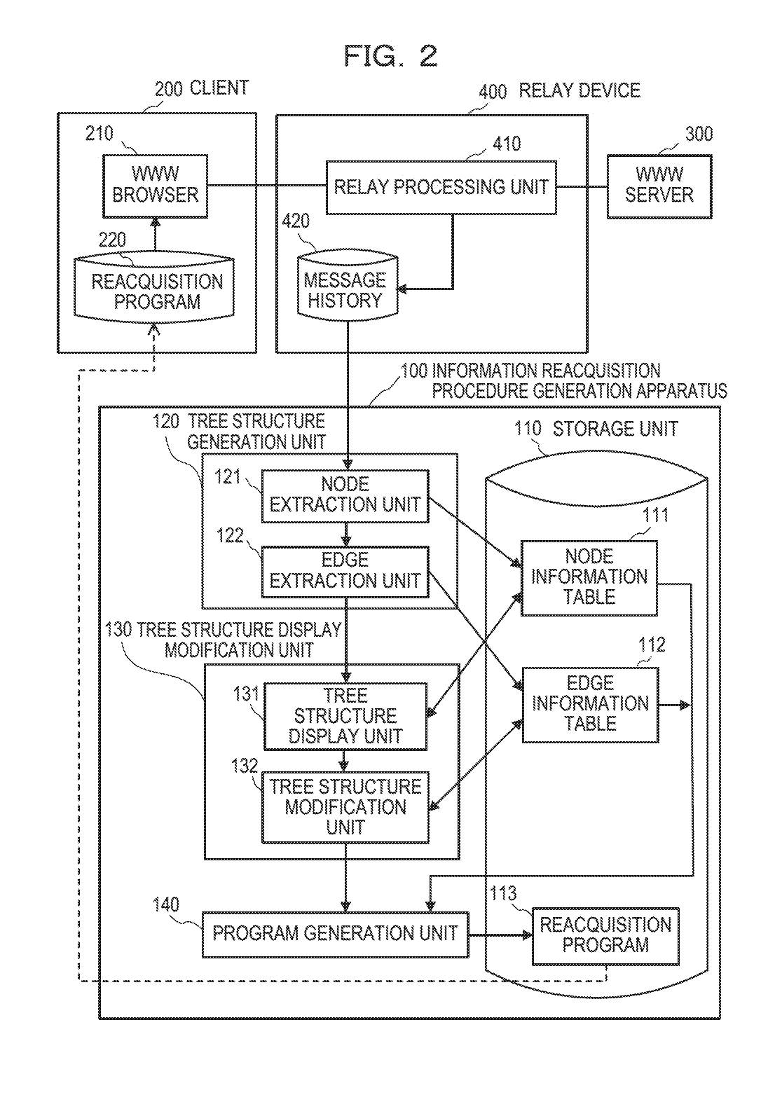

FIG. 2 is a block diagram of an information acquisition system in accordance with an embodiment.

The information acquisition system includes an information reacquisition procedure generation apparatus 100 generating a Web page reacquisition procedure, a client 200 requesting a Web page, a WWW server 300 serving as a Web page providing device, and a relay device 400 relaying messages between the client 200 and the WWW server 300, which are connected through a network.

In response to a Web page request message sent in a preliminarily determined format, the WWW server 300 returns the corresponding Web page information to the requester.

The client 200, which is a device receiving a Web page from the WWW server 300, includes a WWW browser 210 and a reacquisition program (storage unit) 220. The WWW browser 210 performs a process of viewing Web pages. More specifically, the WWW browser 210 accesses the WWW server 300 by a specific procedure, acquires information about the desired Web page, and then reproduces and displays the information on an output device (not illustrated). At this time, if the client 200 has a reacquisition program for executing a procedure for reacquiring the Web page, the reacquisition program stored in the reacquisition program (storage unit) 220 is executed to reacquire information about the Web page. The reacquisition program (storage unit) 220 contains the reacquisition program for executing a procedure for reacquiring any Web page, which is generated by the information reacquisition procedure generation apparatus 100. Alternatively, the client 200 may not have the reacquisition program, but instead, the client 200 may request the information reacquisition procedure generation apparatus 100 to reacquire the information.

The relay device 400 includes a relay processing unit 410 relaying messages and a message history (storage unit) 420 storing the message history. The relay processing unit 410 receives a request from the client 200, relays the request to the WWW server 300, receives a response from the WWW server 300, and returns the response to the client 200. At this time, the relay device 400 stores the information about the relayed request and response in the message history (storage unit) 420 as the message history. When a request is received from the information reacquisition procedure generation apparatus 100, the relay device 400 reads the message history from the message history (storage unit) 420 and returns the information to the information reacquisition procedure generation apparatus 100.

The information reacquisition procedure generation apparatus 100 includes a storage unit 110 storing various kinds of information, a tree structure generation unit 120 generating a tree structure representing the message transitional relationship, a tree structure display modification unit 130 displaying and correcting the tree structure, and a program generation unit 140 generating a program executing the information reacquisition procedure.

The storage unit 110 includes a node information table 111, an edge information table 112, and a reacquisition program 113. The node information table 111 and the edge information table 112 contain message transitional relationship information, namely, information about a node and an edge when the message transitional relationship is represented as a tree structure. The node information table 111 records information about messages extracted in an individual node of the tree structure representing the transitional relationship of a message acquiring a Web page. The edge information table 112 records information specifying the parent node for each node. The reacquisition program 113 is a program generated to execute the reacquisition procedure for reacquiring the specified Web page. The detail about the individual information will be described later.

The tree structure generation unit 120 includes a node extraction unit 121 and an edge extraction unit 122, and serves as a relation analysis unit. In order to treat the Web page transitional relationship as a tree structure, the node extraction unit 121 analyzes the messages recorded in the message history to extract a node. The edge extraction unit 122 extracts an edge.

The node extraction unit 121 acquires the message history from the relay device 400, analyzes the syntax of the messages, and extracts specific data. For example, the node extraction unit 121 extracts a URL as specific data and classifies the similar messages such as the messages having the same URL into a node. Here, the node extraction unit 121 classifies the messages by checking whether or not to match the URL, the request method, the response status code, the response media type, and the response title for HTML. Then, the node extraction unit 121 assigns a node ID for each classification and stores the node ID in the node information table 111. Moreover, the node extraction unit 121 selects a message from the messages belonging to the individual classification (node) and sets the message as a representative message. For example, the node extraction unit 121 sets the first issued message of the message groups classified in a node as the representative message.

The edge extraction unit 122 analyzes the relation between the nodes extracted by the node extraction unit 121. Then, the edge extraction unit 122 estimates the message issuing the representative message for each node and sets the node containing the representative message as the parent node. More specifically, the edge extraction unit 122 puts an edge between the individual nodes and their parent node. The edge extraction unit 122 ensures that an individual node has a parent node. If no parent node is detected from the message history, the edge extraction unit 122 sets a virtually blank page (actually an “uncalled page”) for the parent node. Note that the edge extraction unit 122 estimates the issuer by sequentially searching the message history for the messages issued before the representative message. Moreover, there are various estimation methods, and an appropriate method is selected according to the system. For example, the edge extraction unit 122 may make the estimation by checking whether or not the specific data of the issued request is contained in the issuer's response. Alternatively, the edge extraction unit 122 may make the estimation by checking whether or not the URL of the issued request is contained in the link group of the response from the issuer candidates. Still alternatively, the edge extraction unit 122 may use the method of the issued request, the referrer header, the body (parameter), the location header of the response from the issuer candidates, the form, the URL of the issued request, or the like as a determination material. Here, the edge extraction unit 122 determines whether or not the issuer's URL is contained in the location header and the link group of the response from the issuer candidates. The edge extraction unit 122 stores the extracted edge in the edge information table 112. Thereby, the transitional relationship of the message having a blank page as its root or the Web page called by the message is stored in the edge information table 112.

The tree structure display modification unit 130 includes a tree structure display unit 131 and a tree structure modification unit 132, and serves as a relation presentation modification unit. The tree structure display unit 131 displays a Web page (message) transitional relationship as a tree structure. The tree structure modification unit 132 modifies the tree structure based on an input instruction. The tree structure display unit 131 uses the node information table 111 and the edge information table 112 generated by the tree structure generation unit 120 to display the message transitional relationship in a tree structure. Here, the tree structure is displayed using a GUI (Graphical User Interface). When an instruction is entered by a user, the tree structure modification unit 132 rewrites the node information table 111 and the edge information table 112 based on the instruction.

The program generation unit 140 serves as a reacquisition procedure definition unit. The program generation unit 140 uses the node information table 111 and the edge information table 112 representing the message transitional relationship modified by the tree structure display modification unit 130 to define a procedure for reacquiring a desired Web page, and generates a reacquisition program. For example, the program generation unit 140 sequentially follows the tree structure starting at the root node until reaching a node containing a message acquiring the target information to generate a request message based on the representative message of the node, and defines the procedure for sending the generated request message in sequence.

Here, the hardware configuration of the information reacquisition procedure generation apparatus 100 will be described.

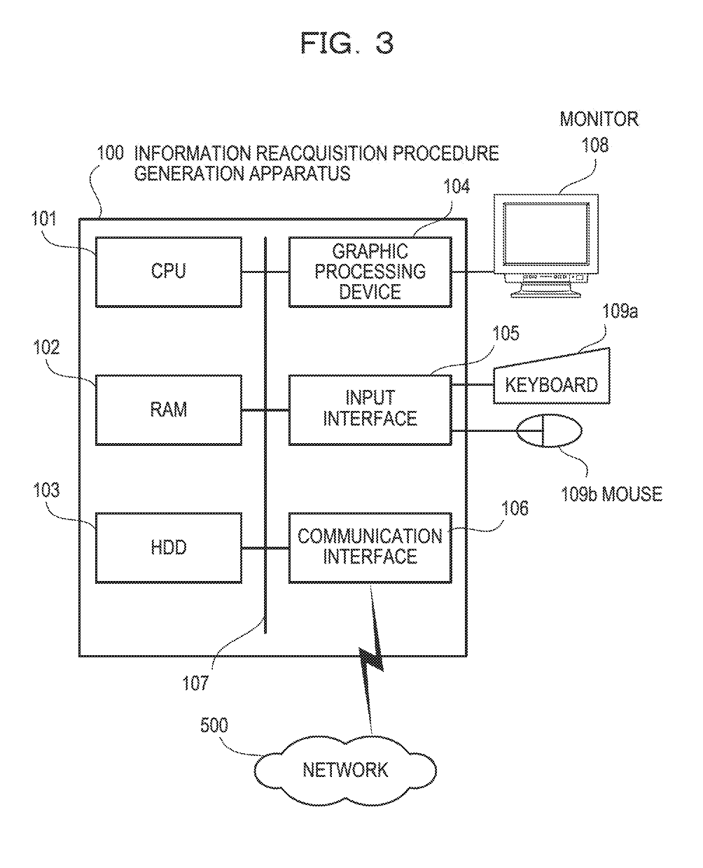

FIG. 3 is a block diagram illustrating the hardware configuration of the information reacquisition procedure generation apparatus.

The entire information reacquisition procedure generation apparatus 100 is controlled by the CPU (Central Processing Unit) 101. The CPU 101 is connected to a RAM (Random Access Memory) 102, an HDD (Hard Disk Drive) 103, a graphic processing device 104, an input interface 105, and a communication interface 106 through a bus 107.

The RAM 102 temporarily stores at least part of the OS (Operating System) and an application program to be executed by the CPU 101. The RAM 102 further stores various kinds of data required for processing by the CPU 101. The HDD 103 stores the OS and the application program. The graphic processing device 104 is connected to a monitor 108 and displays an image on the screen of the monitor 108 in response to an instruction from the CPU 101. The input interface 105 is connected to a keyboard 109a and a mouse 109b and sends a signal from the keyboard 109a or the mouse 109b to the CPU 101 through the bus 107. The communication interface 106 is connected to a network 500, and transfers data to and from the client 200 and the relay device 400 through the network 500.

Such a hardware configuration may provide the processing functions of the information reacquisition procedure generation apparatus 100. Note that the individual hardware configuration of the client 200, the WWW server 300, and the relay device 400 is the same as the hardware configuration of the information reacquisition procedure generation apparatus 100 illustrated in FIG. 3.

Hereinafter, the operation of the information reacquisition procedure generation apparatus 100 and the information reacquisition procedure generation method will be described using specific examples.

When a Web page is requested, the information reacquisition procedure generation apparatus 100 uses a message history containing the messages exchanged between the client 200 and the WWW server 300 to analyze the reacquisition procedure of the Web page which the user wants to acquire.

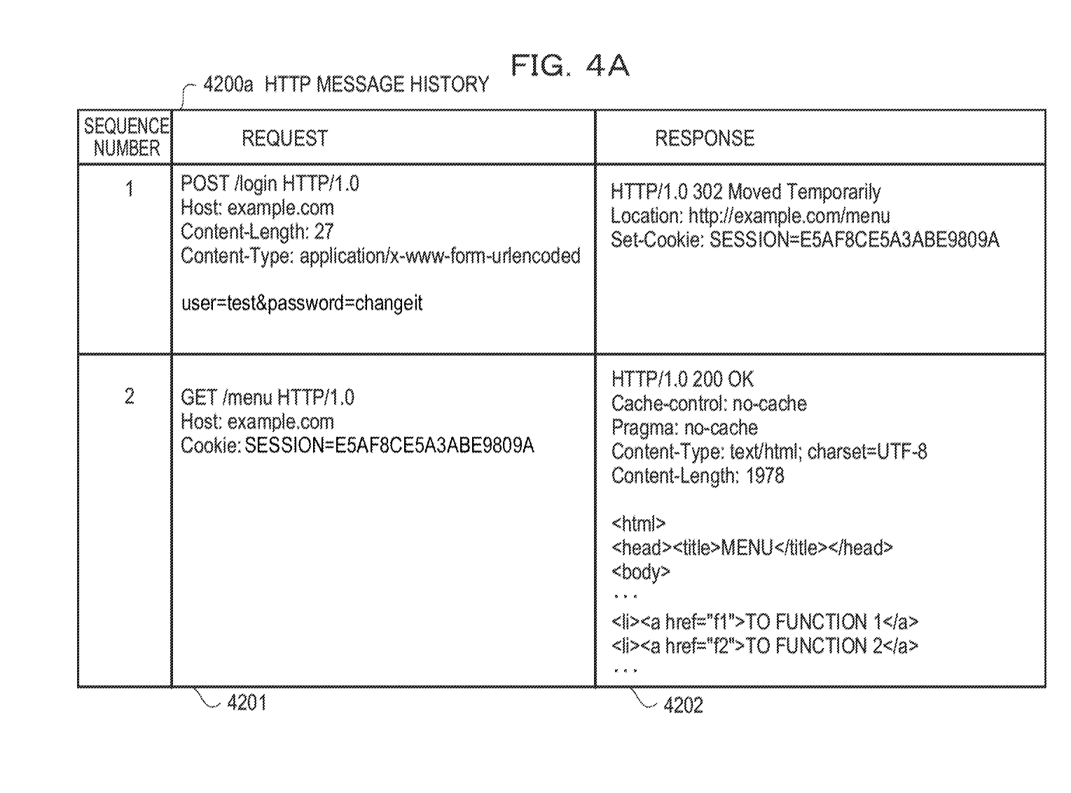

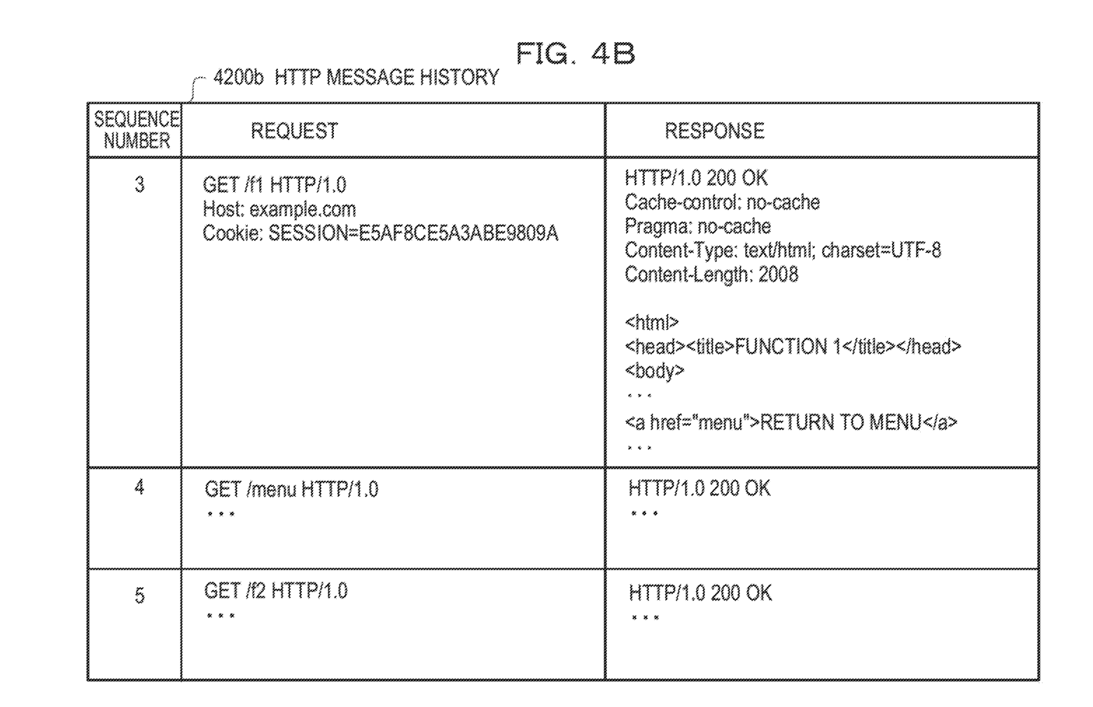

FIGS. 4A and 4B illustrate an example of the message history. FIG. 4A illustrates the first half of the example of the message history. FIG. 4B illustrates the latter half of the example of the message history.

Note that FIGS. 4A and 4B illustrate the history of a message using the HTTP (Hyper Text Transfer Protocol). For convenience of description, FIG. 4A illustrates an HTTP message history 4200a and FIG. 4B illustrates an HTTP message history 4200b, which are two parts of a table.

The HTTP message histories 4200a and 4200b record a request 4201 and response 4202 as a pair in the order of the messages obtained.

The messages are arranged in chronological sequence as they are obtained. The lower the number, the earlier the message is obtained. The request 4201 records a request message sent from the client 200 to the WWW server 300. The response 4202 records a response message sent from the WWW server 300 to the client 200 in response to the request.

In the examples of FIGS. 4A and 4B, a login request (POST/login HTTP/1.0) from the client 200 is accepted (sequence number 1), and then, a menu request (GET/menu HTTP/1.0) is issued (sequence number 2). Then, an information request for function 1 (GET/f1 HTTP/1.0) is issued from the menu (sequence number 3). Further, the menu request (GET/menu HTTP/1.0) is issued again (sequence number 4), and then, an information request for function 2 (GET/f2 HTTP/1.0) is issued from the menu (sequence number 5). Note that the parenthesized sequence numbers corresponds to the sequence numbers of the HTTP message histories 4200a and 4200b.

The tree structure generation unit 120 sequentially analyzes the request message of the request 4201 and the response message of response 4202 of the HTTP message history 4200 to obtain the tree structure information (the node information table 111 and the edge information table 112) representing the message transitional relationship.

The node extraction unit 121 extracts specific data from the request message and the response message and classifies the messages into nodes by comparison. Here, the node extraction unit 121 classifies, into the same node, the messages matching the URL, the request method, the response status code, the response media type, and the response title (in the case of HTML). More specifically, first, the node extraction unit 121 assigns a message ID to an individual message to identify the individual message. In the examples of FIGS. 4A and 4B, a message shown in sequence number 1 of the HTTP message history 4200a is assigned to M1 as the message ID, a message shown in sequence number 2 is assigned to M2, a message shown in sequence number 3 of the HTTP message history 4200b is assigned to M3, a message shown in sequence number 4 is assigned to M4, and a message shown in sequence number 5 is assigned to M5. Subsequently, the node extraction unit 121 classifies the messages M1 to M5 into an individual node. The URL (http://example.com/menu), the request method (GET), and the response status code (200) are common to M2 and M4. If the response media type (text/html) and the title (menu), part of which is not illustrated, are also common to M2 and M4, the messages M2 and M4 are classified in the same node. In contrast, the remaining messages M1, M3, and M5 differ in URL or the like, and thus each message is classified into a different node respectively.

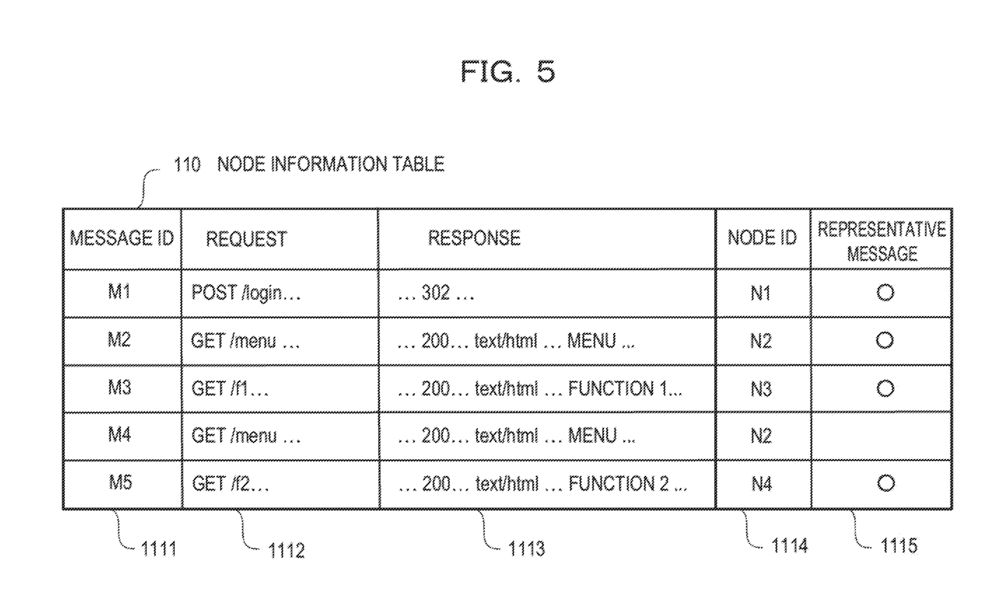

In this manner, the node extraction unit 121 generates the node information table 111 by registering the assigned nodes. FIG. 5 is an example of the node information table.

The node information table 111 is generated by analyzing the HTTP message histories 4200a and 4200b in the above described manner. The node information table 111 has the information items including a message ID 1111, a request 1112, a response 1113, a node ID 1114, and a representative message 1115.

The message ID 1111 lists the message identification characters set in the order they are recorded in the HTTP message histories 4200a and 4200b. The request 1112 lists the request messages recorded in the HTTP message histories 4200a and 4200b. The response 1113 lists the response messages recorded in HTTP message histories 4200a and 4200b. The node ID 1114 lists the node IDs assigned by the node extraction unit 121. The representative message 1115 indicates whether or not the corresponding message is a representative message. In the example of FIG. 5, the representative message is indicated by a circle. Note that of the messages classified in the same node, the message having the lowest message ID number (earliest issued message) is selected as the representative message. In the example of FIG. 5, the message M1 is the representative message of the node N1. The messages M2 and M4 are classified in the node N2. The message ID number of the message M2 is lower than that of the message M4, and thus the message M2 is the representative message of the node N2. Likewise, the message M3 is the representative message of the node N3, and the message M5 is the representative message of the node N4.

Then, the edge extraction unit 122 estimates the parent-child relationship between the nodes. First, the edge extraction unit 122 sets “N0” to the node ID of a node corresponding to a blank page. The node N0 is a node having no messages classified therein. Then, the edge extraction unit 122 determines the parent node for each node other than the node N0, and stores the information in the edge information table 112.

Here, the edge extraction unit 122 determines whether or not the URL of an issued request is contained in the location header and the link group of the response from the issuer candidate. The edge extraction unit 122 treats the issuer candidate as a message issued before this request. In the example of FIG. 5, the message M1 classified in the node N1 has no message issued before the message M1, and thus the node N0 is set to the parent node. Then, the issuer candidate of the message M2 classified in the node N2 has the message M1 (node N1) issued before the message M2. Here, the URL (http://example.com/menu) of the issued request of the message M2 is the same as the URL contained in the location header of the response from the issuer candidate. Then, the node N1 is set to the parent node of the node N2. Note here that if a corresponding message is not found, the node N0 is set to the parent node. In this manner, the edge extraction unit 122 performs analysis in series to determine the parent node for each node and generates the edge information table 112.

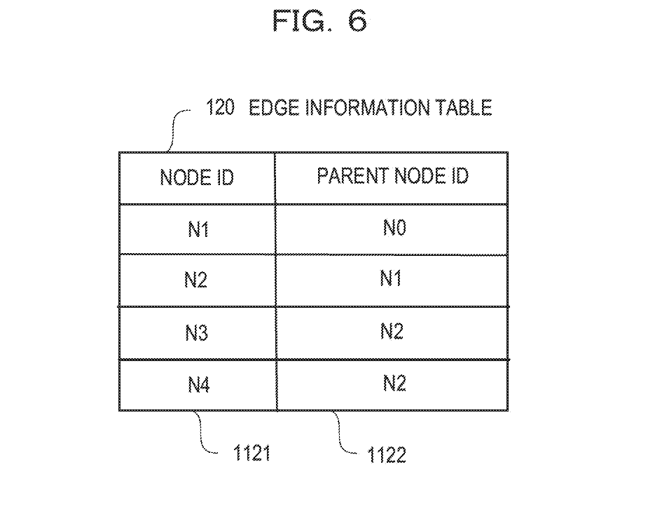

FIG. 6 is an example of the edge information table.

The edge information table 112 stores the parent nodes analyzed and determined as described above for each node stored in the node information table 111. The edge information table 112 lists a node ID 1121 and a parent node ID 1122 having a parent node corresponding to the node stored in the node ID 1121. The node IDs stored in the node ID 1121 are the same as the node IDs stored in the node ID 1114 of the node information table 111. The parent node ID 1122 stores the node ID of the parent node which is an issuer of the node stored in the node ID 1121. FIG. 6 shows the parent-child relationship such that the parent node of the node N1 is the node N0, the parent node of the node N2 is the node N1, and the parent node of the node N3 and the node N4 is the node N2.

In this manner, the tree structure generation unit 120 generates the node information table 111 and the edge information table 112. Then, the tree structure display modification unit 130 displays and modifies the tree structure representing the message transitional relationship. The tree structure display unit 131 uses the node information table 111 and the edge information table 112 to display a tree display screen showing the message transitional relationship.

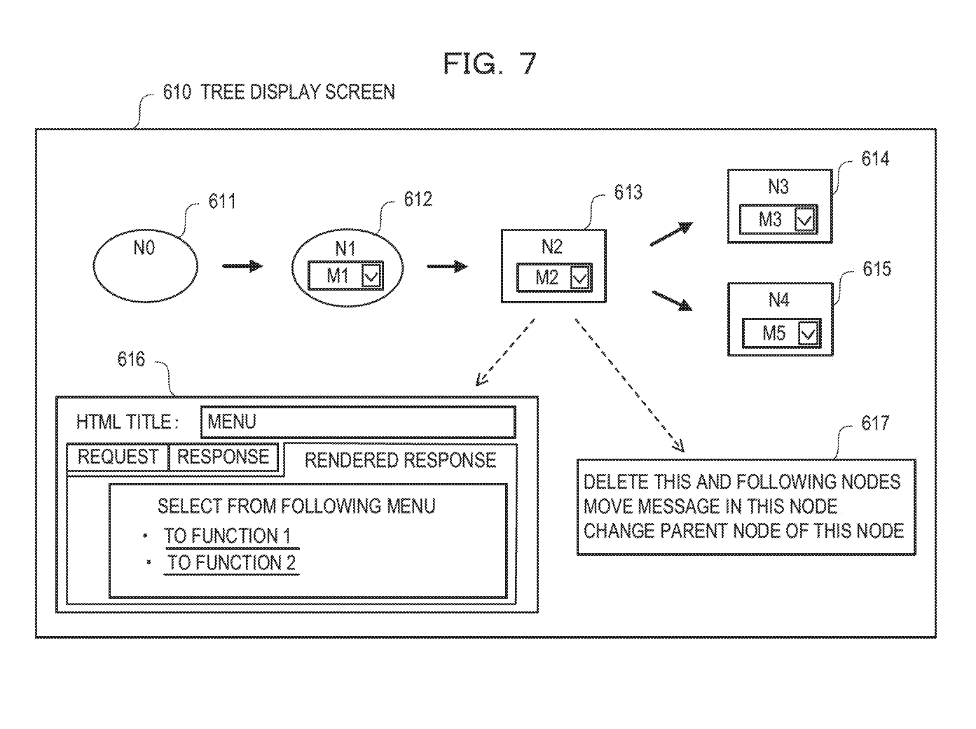

FIG. 7 is an example of the tree display screen displayed by the tree structure display unit 131. The example of FIG. 7 illustrates a display screen based on the node information table 111 and the edge information table 112.

The tree display screen 610 shows icons indicating an individual node such as the node N0 (611), the node N1 (612), the node N2 (613), the node N3 (614), and the node N4 (615), which are arranged based on the parent-child relationship between the nodes. In the following description, a node name followed by parenthesized number denotes an icon on the display screen indicated by the number. In the example of FIG. 7, the leftmost node N0 (611) indicates the root node of the tree structure. A child node having the node N0 as its parent node is placed adjacently on the right side of the node N0. Here, the child node having the node N0 as its parent node is the node N1 (612). Likewise, based on the edge information table 112, the node N2 (613) having the node N1 as its parent node, the node N3 (614) having the node N2 as its parent node, and the node N4 (615) having the node N2 as its parent node are arranged in sequence. Moreover, an edge (an arrow in the figure) is indicated in the direction from the parent node represented in the edge information table 1120 to the child node.

The node icons other than the node N0 (611) display a message group classified in the node information table 111 in a list format (combo box) with the representative message on the top. The icon may be shaped or colored differently depending on the type of message. FIG. 7 illustrates a rectangular icon when the representative message is an HTML, and an elliptic icon when the representative message is something other than an HTML.

An individual node icon other than the node N0 (611) may be selected by a mouse or the like. When a node icon is selected, the detail about the representative message of the selected node is displayed separately. In the example of FIG. 7, when the node N2 (613) is selected, a detail screen 616 about the representative message is displayed. Here, a display screen is displayed based on the HTML file acquired by the representative message M2. This allows the user to easily understand the information acquired by the message.

In this manner, the tree structure display unit 131 displays the message transitional relationship as a tree structure, and thus the user can easily understand the message transitional relationship. In the example of FIG. 7, the user can understand that the information about the node N3 may be obtained by following the node N1 and the node N2 in that order. In other words, the user can understand that the messages are sent in the order of the representative message M1, the representative message M2, and the representative message M3, and the information corresponding to the message M3 may be obtained by following the above messages. Likewise, the user can understand that the information about the node N4 may be obtained by following the node N1 and the node N2 in that order. The message sending procedure is in the order of the representative message M1, the representative message M2, and the representative message M5.

Hereinafter, the modification of the tree structure will be described. Here, when a node is selected by an operation of a mouse or the like, the tree structure modification unit 132 displays a menu (hereinafter referred to as a “modification menu”) for modifying an individual node as a pop-up menu on the node. Note that the node N0 cannot be modified. The tree structure modification unit 132 displays the modification menu 617 listing such a modification instruction as “Delete this and following nodes”, “Move message in this node”, “Change parent node of this node”. The user may select one of these modification instructions by an operation of a mouse or the like.

Now, the individual case where a modification instruction is selected by the user will be described.

First, the case where the instruction “Move message in this node” is selected from the modification menu 617 will be described.

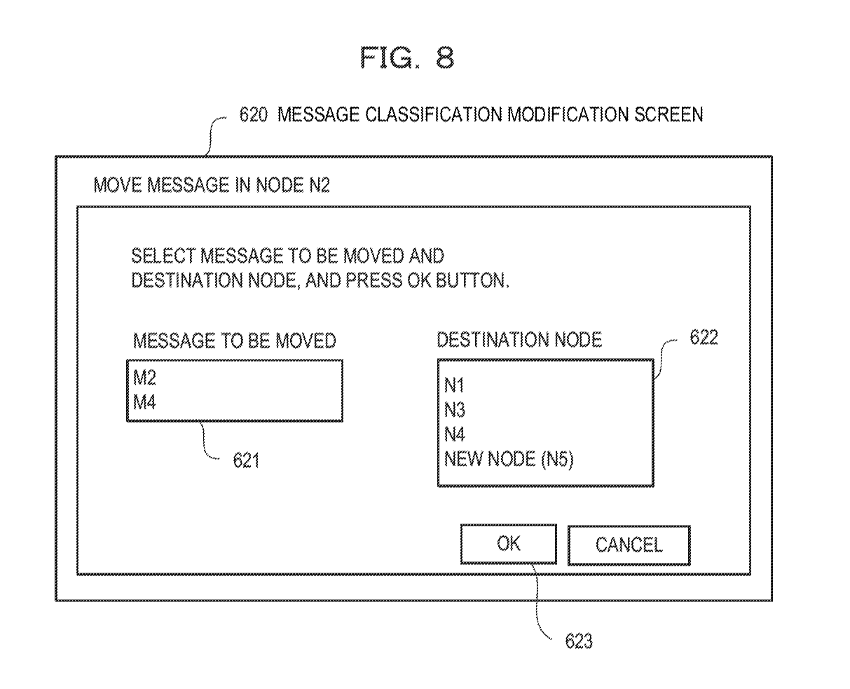

When the message movement is selected, the tree structure modification unit 132 displays a message classification modification screen for modifying the message classification (classified nodes). FIG. 8 is an example of the message classification modification screen.

When the node N2 is selected and “Move message in this node” is selected on the tree display screen 610 in FIG. 7, the tree structure modification unit 132 displays the message classification modification screen 620.

The message classification modification screen 620 displays a message-to-be-moved field 621, a destination node field 622, and an OK button 623. The message-to-be-moved field 621 displays IDs of the messages belonging to the node specified for movement. In this example, the message M2 and the message M4 classified in the node N2 are displayed. The destination node field 622 displays a list of nodes which may be specified as the destination to which the message is moved. In this example, existing nodes N1, N3, and N4, and a new node are displayed. An unused node ID is set to the new node. In the example of FIG. 8, N5 is set as the new node ID. The user selects a message to be moved from the message-to-be-moved field 621 and selects the destination node from the destination node field 622 by an operation of a mouse or the like. When the OK button 623 is pressed, the tree structure modification unit 132 moves the specified message to the specified node.

For example, consider the case where M2 is selected as the message to be moved, and the new node (N5) is selected as the destination to which the message is moved. With this selection, the tree structure modification unit 132 moves the message M2 classified in the node N2 to the node N5. More specifically, the tree structure modification unit 132 updates the node ID related to the message M2 in the node information table 111 to “N5” and sets the message M2 to the representative message of the node N5. With this update, the tree structure modification unit 132 updates the corresponding field of the representative 1115 by setting the representative message of the node N2 to the message M4. Further, the tree structure modification unit 132 adds “N5” to the node ID 1121 of the edge information table 112. At this time, the parent node of the node N5 inherits the parent node of the original node N2 in which the moved message M2 has been classified, and “N1” is registered.

Further, the tree structure display unit 131 uses the modified node information table 111 and the edge information table 112 to update the tree display screen 610 to the state of the modified tree structure.

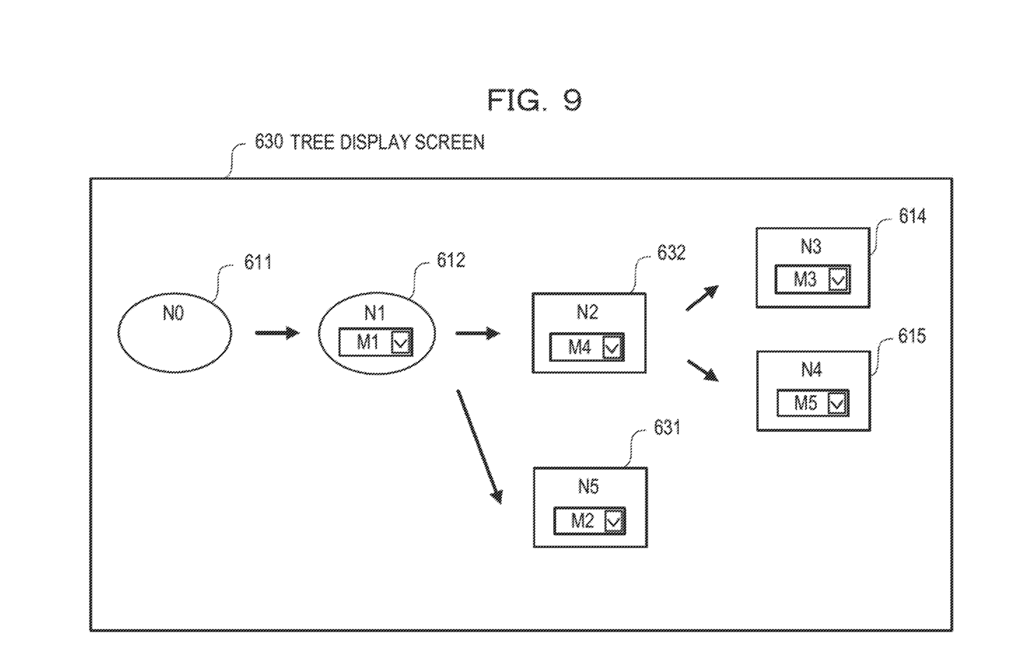

FIG. 9 is an example of the tree display screen displayed by the tree structure display unit 131 after the message classification is modified.

The tree display screen 630 displays the modified state of the tree display screen 610 in which the message M2 is moved from the node N2 to the node N5. The same numbers are assigned to the nodes having no modification from the tree display screen 610.

On the tree display screen 630 after modification, a newly added node N5 (631) is placed under the node N1 (612). The message M2 is set as the representative message of the node N5. With this modification, the representative message of the node N2 (632) is changed to the message M4. Nothing other than this is modified.

As described above, the user may easily modify the message transitional relationship simply by an operation of the GUI (Graphical User Interface).

The message classification modification may be applied to any message in any of the nodes except the node N0. Alternatively, the message M3 classified in the node N3 (614) may be moved to the node N4. Hereinafter, such a case will be described. On the tree display screen 610 illustrated in FIG. 7, the user selects the node N3 and selects “Move message in this node” from the modification menu 617. With this selection, the message classification modification screen 620 related to the node N3 is displayed. First, the user selects the message M3 and then selects the node N4 as the destination. With this operation, the node ID 1114 of the message M3 in the node information table 111 is modified to “N4”. The message M5 has already been set as the representative message of the node N4, and thus the message M3 is not set as the representative message. Note that the edge information table 112 has nothing to be modified.

The tree structure display unit 131 uses the modified node information table 111 and edge information table 112 to update the tree display screen 610 to the state of the modified tree structure.

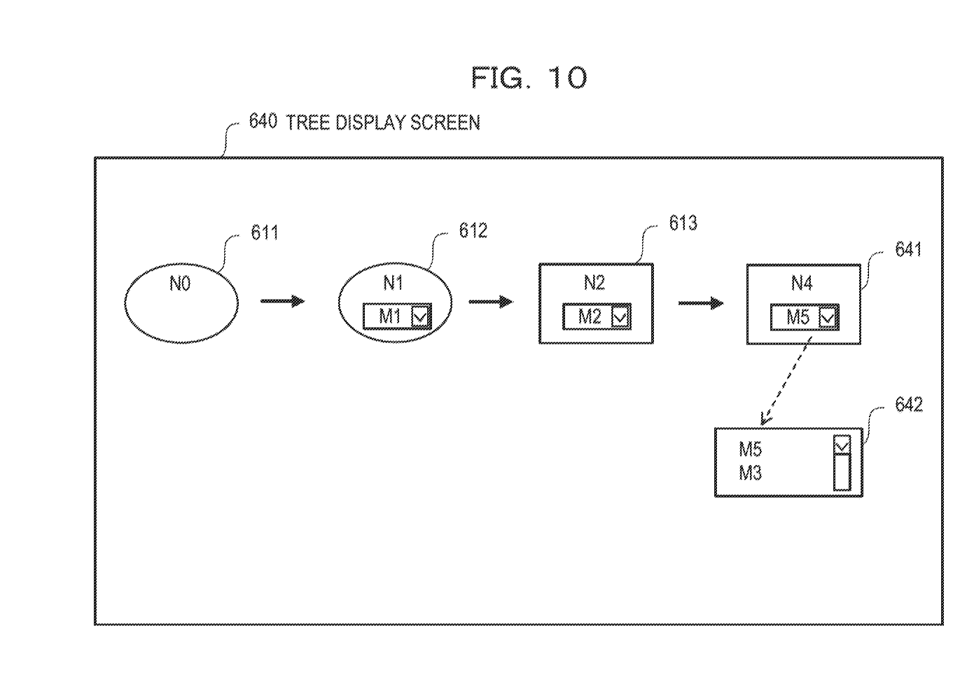

FIG. 10 is another example of the tree display screen displayed by the tree structure display unit 131 after the message classification is modified.

The tree display screen 640 illustrates the modified state of the tree display screen 610, in which the message M3 is moved from the node N3 to the node N4. The same numbers are assigned to the nodes having no modification from the tree display screen 610.

On the tree display screen 640, the node N3 having no message is deleted from the display screen and, as a result, the node N2 (613) has only one child node N4 (641). The representative message of the node N4 is modified from the message M3 to the message M5, and thus the message M3 is not displayed in the node N4 (641). When the message list screen 642 is selected, the moved message M3 is displayed. Note that user may arbitrarily set the representative message. For example, the user may set the message M3 as the representative message by a simple operation using a GUI.

Now, the case where the instruction “Delete this and following nodes” is selected from the modification menu 617 will be described. When the message deletion is selected, the tree structure modification unit 132 deletes not only the selected node but also any nodes (hereinafter referred to as a descendant node) derived from the selected node including a child node thereof.

For example, in the state where the node N2 (613) is selected on the tree display screen 610 illustrated in FIG. 7, consider the case where the instruction “Delete this and following nodes” is selected from the modification menu 617. In this case, the tree structure modification unit 132 deletes not only the selected node N2 (613) but also its descendant nodes such as the node N3 (614) and the node N4 (615). For example, the tree structure modification unit 132 deletes the selected node N2 from the node ID 1121 of the edge information table 112. Next, the tree structure modification unit 132 searches the parent node ID 1122 for “N2” to find the corresponding node ID 1121. Here, “N3” and “N4” are found. Then, the tree structure modification unit 132 deletes these nodes from the node ID 1121. Next, the tree structure modification unit 132 searches for a node having the deleted node N3 and node N4 as its parent node. Here, such a node is not found. Then, the tree structure modification unit 132 terminates the deletion process. With this process, the node information table 111 is also modified accordingly.

Further, the tree structure display unit 131 uses the modified node information table 111 and edge information table 112 to update the tree display screen 610 to the state of the modified tree structure.

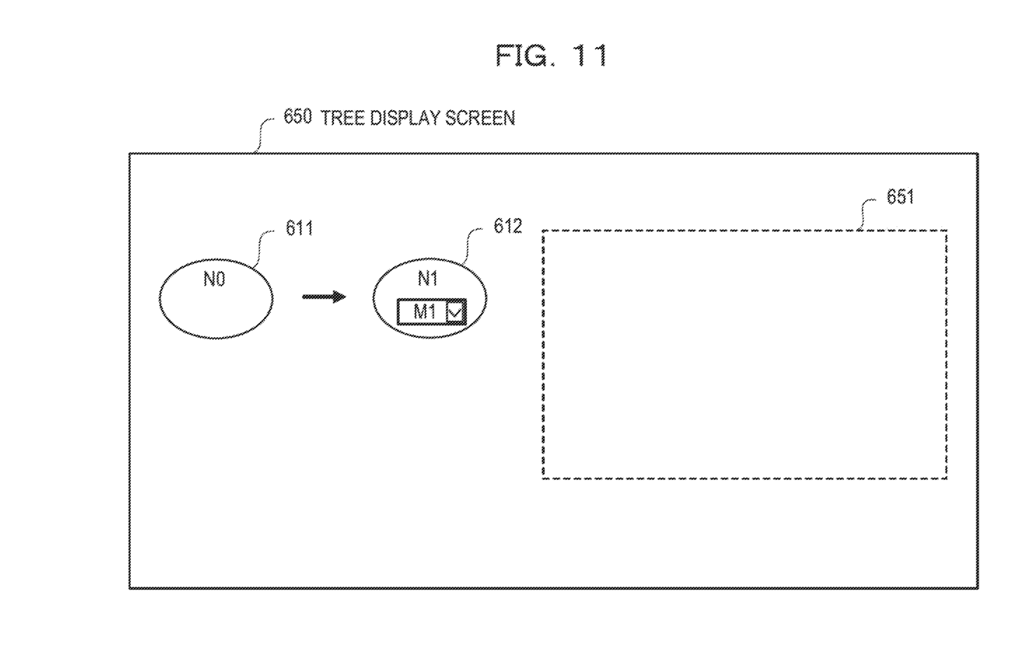

FIG. 11 is an example of the tree display screen displayed by the tree structure display unit 131 after the nodes are deleted.

The tree display screen 650 illustrates the modified state of the tree display screen 610, in which the node N2 and the following nodes are deleted. The same numbers are assigned to the nodes having no modification from the tree display screen 610.

There is no change on the tree display screen 650 except the node N0 (611) and the node N1 (612) preceding the node N2 which are selected for deletion. The selected node N2 and its descendant nodes such as the node N3 and the node N4 are deleted, and nothing is displayed in the region 651 which displayed their icons before.

In this manner, when a node is selected for deletion, the tree structure modification unit 132 follows the edge to automatically delete any descendant node storing a message associated with the deleted node.

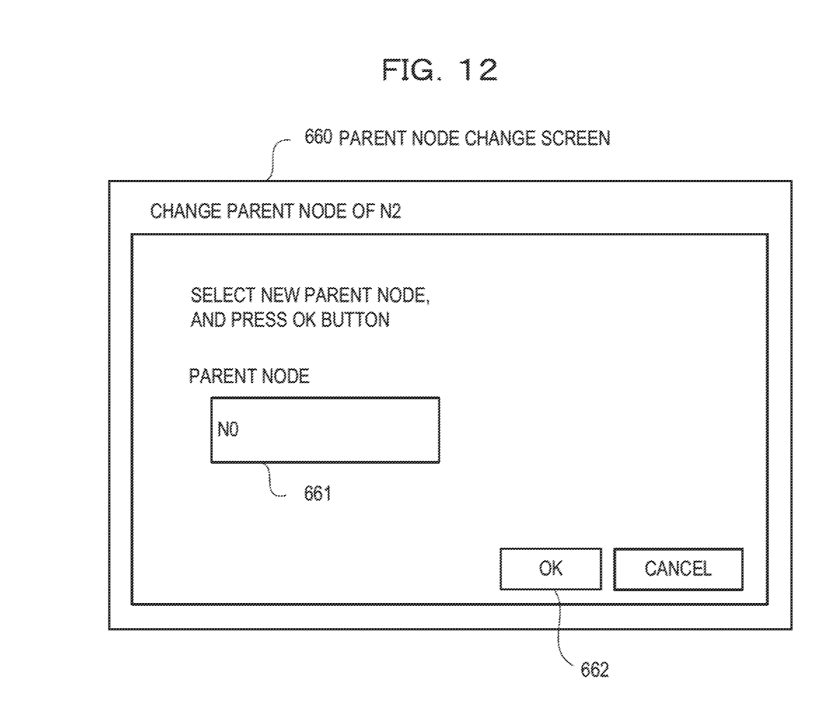

Next, the case where the instruction “Change parent node of this node” is selected from the modification menu 617 will be described. When the parent node change is selected, the tree structure modification unit 132 displays a parent node change screen for modifying the relationship between the nodes. FIG. 12 is an example of the parent node change screen.

When the node N2 is selected and “Change parent node of this node” is selected on the tree display screen 610 in FIG. 7, the tree structure modification unit 132 displays a parent node change screen 660.

The parent node change screen 660 displays a parent node field 661 and an OK button 662. The parent node field 661 displays a list of nodes which may be specified as a parent node candidate from all the nodes except the currently selected node and its descendant node group. The user selects a node ID to be newly set as the parent node. When the OK button 662 is pressed, the tree structure modification unit 132 changes the parent node to the newly selected node.

In the example of FIG. 12, an instruction is issued to change the parent node of the selected node N2 to the node N0. In this case, the tree structure modification unit 132 modifies the parent node ID 1122 corresponding to the node N2 in the edge information table 112 from “N1” to “N0”. The node information table 111 has nothing to be modified.

The tree structure display unit 131 uses the modified edge information table 112 and node information table 111 to display a tree display screen.

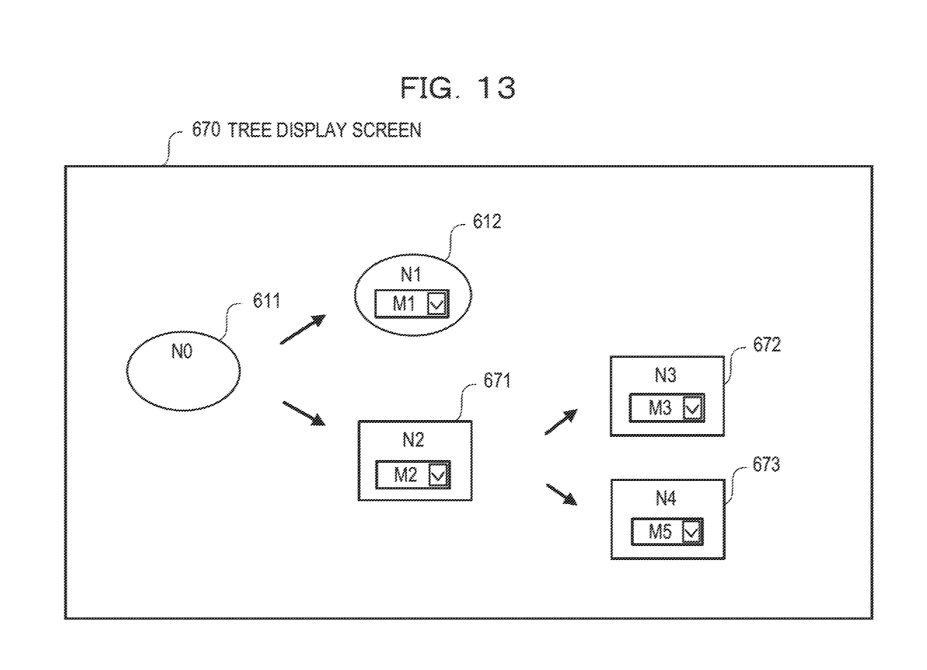

FIG. 13 is an example of the tree display screen displayed by the tree structure display unit 131 after the parent node is changed.

The tree display screen 670 illustrates the modified state of the tree display screen 610, in which the parent node of the node N2 is changed from the node N1 to the node N0. The same numbers are assigned to the nodes having no modification from the tree display screen 610.

On the tree display screen 670, the node N2 (671), and the node N3 (672) and N4 (673) having the node N2 (671) as its parent node are displayed with the node N0 (611) as the parent node.

In this manner, when a parent node is modified, the tree structure modification unit 132 automatically moves not only the selected node but also the descendant nodes thereof.

The tree structure display modification unit repeats the above operation to modify the node information table 111 and the edge information table 112 and sends the modified message transitional relationship information to the program generation unit 140.

The program generation unit 140 acquires the message transitional relationship represented by the node information table 111 and the edge information table 112 and generates a program so as to reacquire the representative message for each node. The reacquisition program of a node first reacquires the parent node of the node. Then, the reacquisition program generates a request based on the last message. If the parent node is “N0” the reacquisition program does not reacquire the parent node, but simply reuses the request of the representative message as is. Various methods may be considered as a method for generating a request for the message to be reacquired based on the last response. For example, the reacquisition program may search for the link corresponding to the message to be reacquired and generate a request. According to the embodiment, the reacquisition program may search for the link corresponding to the message to be reacquired and generate a request. Moreover, the reacquisition program generates a program which displays an error message if the response to the generated request does not match the original response (the response to the representative message). Various methods may be considered as a method of determining whether or not the responses match with each other. For example, the reacquisition program may compare specific data in the responses. As the specific data, a response status code is well known. According to the embodiment, if one of the status code, the media type, and the title (in the case of HTML) does not match, the reacquisition program determines that the responses do not match.

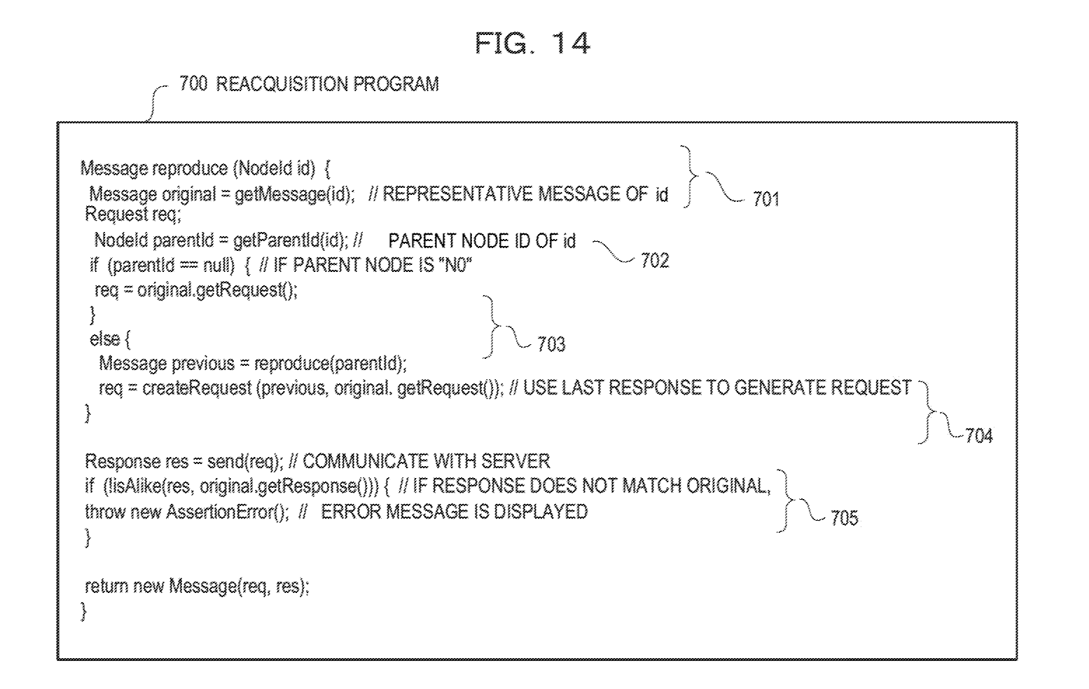

FIG. 14 is an example of the reacquisition program generated by the program generation unit 140.

The process flow of the reacquisition program 700 will be described. First, the reacquisition program 700 uses the “getMessage(NodeId)” to acquire the representative message of the node argument (NodeId) from the node information table 111 (701). Then, the reacquisition program 700 uses the “getParentId” to acquire the parent node ID of the node argument from the edge information table 112 (702). If the result is null, the reacquisition program 700 reuses the request of the representative message (703). If the result is not null, the reacquisition program 700 uses the last response (first argument) to generate the request of the message to be reacquired (704). If the response does not match the original response by the communication with the server, the reacquisition program 700 also performs a process of displaying an error message (705).

In this manner, the program generation unit 140 uses the node information table 111 and the edge information table 112 to generate the reacquisition program 700 for reacquiring a desired message. The use of the generated reacquisition program 700 allows the user to easily acquire the desired Web page information.

Now, a procedure for generating the information reacquisition program in accordance with the embodiment will be described with reference to the flowchart.

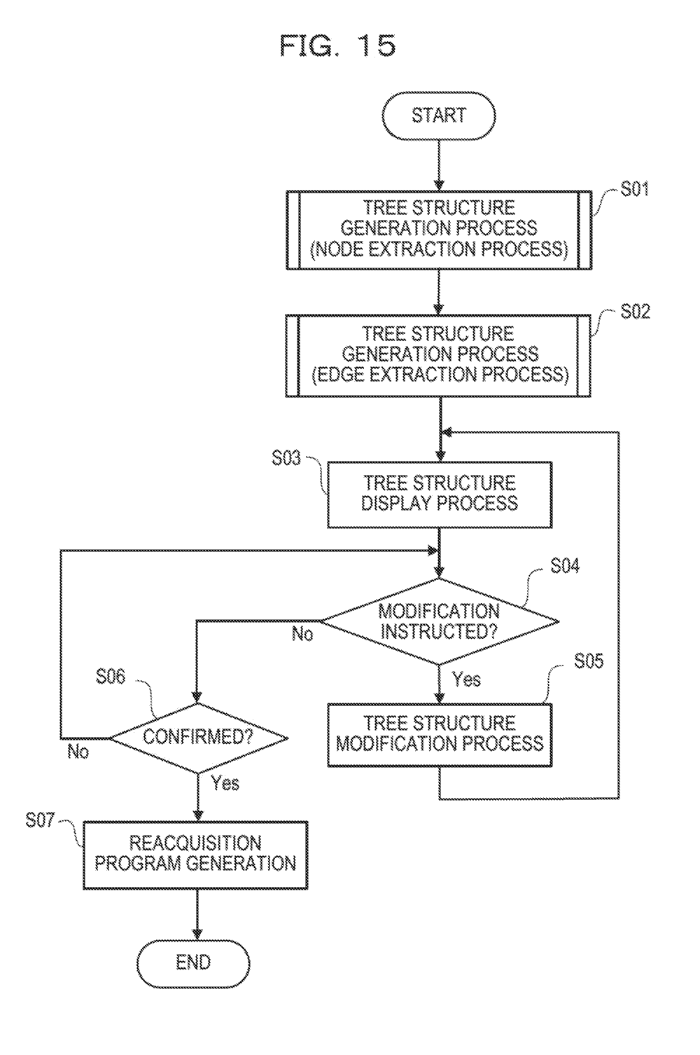

FIG. 15 is a flowchart showing the procedure for generating the information reacquisition program.

[S01] The node extraction unit 121 performs a node extraction process of extracting a node from the message history, which is part of the tree structure generation process of generating a tree structure representing a Web page transitional relationship. The detail will be described later.

[S02] The edge extraction unit 122 performs an edge extraction process of extracting an edge, which is part of the tree structure generation process of generating a tree structure representing a Web page transitional relationship. The detail will be described later.

[S03] The tree structure display unit 131 uses the node information extracted at S01 and the edge information extracted at S02 to display the tree structure representing the Web page transitional relationship on a display device.

[S04] The tree structure modification unit 132 checks whether or not the user enters a modification instruction after the user confirms the Web page transitional relationship on the display device. If a modification instruction is entered, the tree structure modification unit 132 process moves to S05. If no modification instruction is entered, the tree structure modification unit 132 process moves to S06.

[S05] When a modification instruction of the tree structure is entered, the tree structure modification unit 132 modifies the tree structure according to the modification instruction. Further, the tree structure modification unit 132 updates the information about the node information table 111 and the edge information table 112 according to the modified tree structure. Afterward, the process returns to S03 and the procedure is repeated starting at the tree structure display process based on the updated node information table 111 and the edge information table 112.

[S06] If no modification instruction is entered, the tree structure modification unit 132 checks whether or not the user confirms the tree structure. If the user confirms the tree structure, the tree structure modification unit 132 process moves to S07. If the user does not confirm the tree structure, the tree structure modification unit 132 returns the process to S04, and checks whether or not the user enters a modification instruction.

[S07] If the user confirms the tree structure, the program generation unit 140 uses the confirmed tree structure to generate a reacquisition program for acquiring a desired Web page.

When the above processing procedure is executed, the information reacquisition procedure generation apparatus 100 uses the message history to generate the reacquisition program for reacquiring the Web page that the user wants to acquire. When the client 200 executes this reacquisition program, the user can refer to the desired Web page with a simple operation.

Now, the detail procedure for the tree structure generation process will be described in the order of the node extraction process and the edge extraction process.

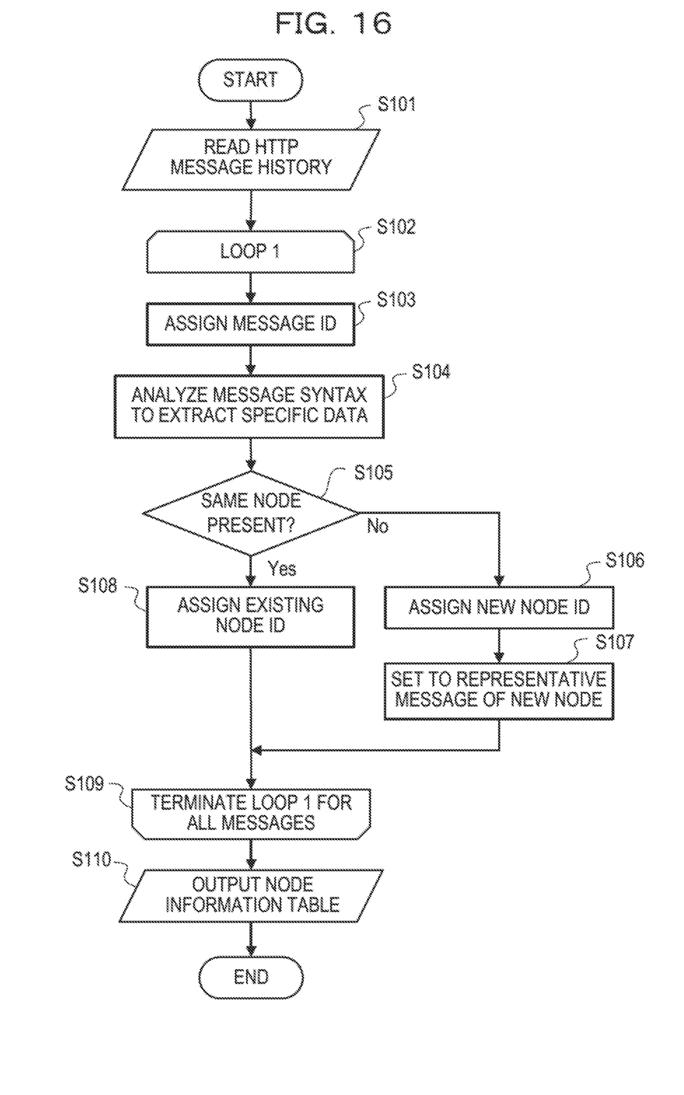

FIG. 16 is a flowchart illustrating the procedure for the tree structure generation process (node extraction process).

[S101] The node extraction unit 121 reads an HTTP message history about the HTTP message exchanged between the client 200 and the WWW server 300 recorded by the relay device 400. The read HTTP message history covers all the messages recorded during a specific period.

[S102] The node extraction unit 121 performs a process of loop 1 ending at S109 on the messages recorded in the message history read at S10.

[S103] The node extraction unit 121 selects an unprocessed pair of messages of the pairs of messages (requests and responses) recorded in the message history, assigns a message ID to the pair of messages, and stores the message ID in the node information table 111. The node extraction unit 121 generates the message ID, for example, by a combination of an identification character M identifying a message and a number assigned in the order the number is issued. At this point of time, the node information table 111 stores a request message and a response message extracted from the message history in association with the message ID.

[S104] The node extraction unit 121 analyzes the syntax of a message extracted at S103 to extract specific data. The node extraction unit 121 extracts specific data such as a URL and a request method.

[S105] The node extraction unit 121 uses the extracted specific data to check whether or not a node containing the same or a similar message as this message has already been registered. More specifically, the node extraction unit 121 compares the extracted specific data and the specific data of the messages already registered in the node information table 111 to check whether the same message is present or not. If the same message is present, the node extraction unit 121 classifies the message in the same node as that of the already registered message. Then, the node extraction unit 121 process moves to S108. If the same message is not present, the node extraction unit 121 process moves to S106.

[S106] If the message cannot be classified in the same node, the node extraction unit 121 assigns a new node ID to this message. The node extraction unit 121 registers the assigned node ID in the node ID field of the node information table 111 corresponding to this message.

[S107] Further, the node extraction unit 121 sets the message to the representative message of the new node. More specifically, the node extraction unit 121 puts a circle mark, for example, in the representative field of the node information table 111 corresponding to this message. Then, the node extraction unit 121 process moves to S109.

[S108] If the message can be classified in the same node as the already registered node (existing node), the node extraction unit 121 assigns the node ID of the existing node. The node extraction unit 121 registers the assigned node ID in the node ID field of the node information table 111 corresponding to this message.

[S109] The node extraction unit 121 checks whether or not the processing of all the messages recorded in the read message history has been completed. If the processing of all the messages is determined to be incomplete, the node extraction unit 121 returns to S102. If the process is determined to be completed, the node extraction unit 121 terminates loop 1 and the process moves to S110.

[S110] The node extraction unit 121 outputs the generated node information table 111.

When the above processing procedure is executed, the node extraction unit 121 assigns a node to a message recorded in the message history and then registers the node in the node information table 111.

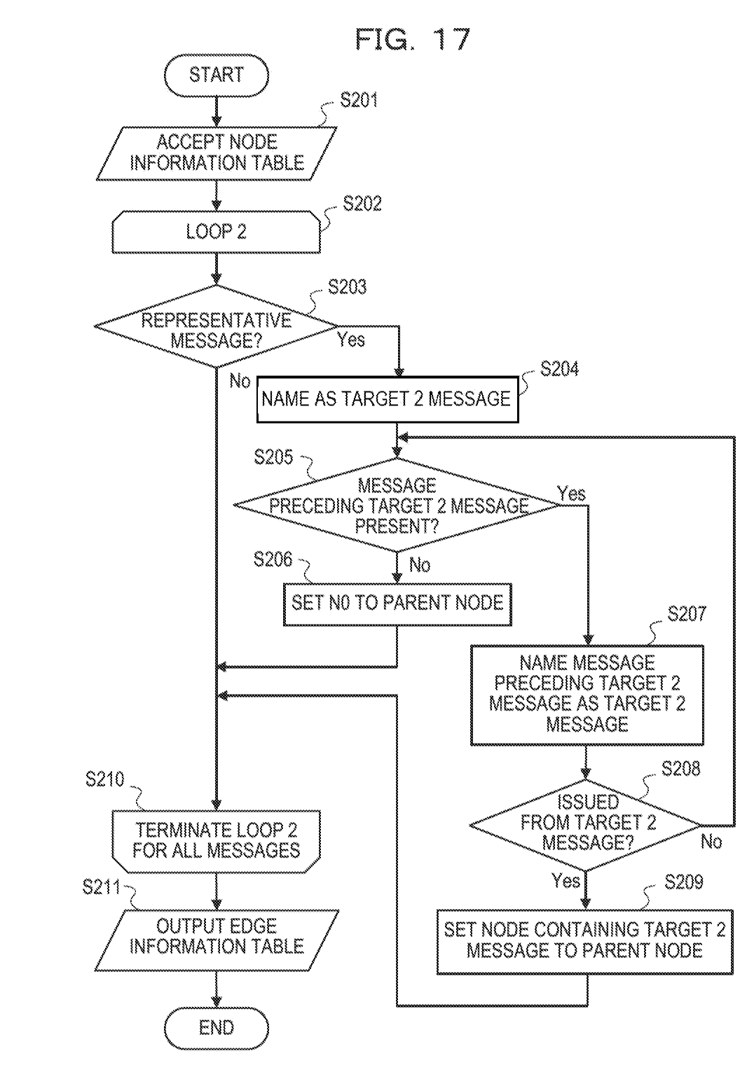

FIG. 17 is a flowchart showing a procedure for a tree structure generation process (edge extraction process).

[S201] The edge extraction unit 122 performs an acceptance process on the node information table 111 generated by the node extraction unit 121.

[S202] The edge extraction unit 122 selects an unprocessed target message and performs the process of loop 2 ending at S210 until the processing of all the messages registered in the accepted node information table 111 has been completed.

[S203] The edge extraction unit 122 checks whether or not the selected target message is a representative message. The edge extraction unit 122 makes the determination by referring to the representative field of the node information table 111. If the selected target message is a representative message, the edge extraction unit 122 process moves to S204. If the selected target message is not a representative message, the edge extraction unit 122 process moves to S210.

[S204] The edge extraction unit 122 names the representative message as a target 2 message. The target 2 message is a message in the node treated as a parent node candidate at this point of time. In other words, at the starting point of time, the edge extraction unit 122 temporarily treats the node of the target message as a parent node candidate.

[S205] The edge extraction unit 122 checks whether or not there is a message issued chronologically before the target 2 message currently named as a target 2 message. According to the node information table 111, the message ID is assigned in the order as the message is issued, and thus the edge extraction unit 122 makes the determination by checking whether or not the value of the message ID is lower than that of the target 2 message. If a previous message is not present, the edge extraction unit 122 process moves to S206. If a previous message is present, the edge extraction unit 122 process moves to S207.

[S206] If there is no message before the target 2 message, the edge extraction unit 122 sets its parent node to the node N0 and registers the target message in an appropriate location of the edge information 244. This is because the target message is not issued according to the other message. Then, the edge extraction unit 122 process moves to S210.

[S207] If there is a message before the target 2 message, the edge extraction unit 122 renames the message before this target 2 message as a target 2 message. In other words, the edge extraction unit 122 sets the parent node candidate to the node containing an earlier issued message.

[S208] The edge extraction unit 122 analyzes the target message (message selected at S202) and the target 2 message (parent node candidate) extracted at S207. Then, the edge extraction unit 122 checks whether or not the target message is estimated to be issued from the target 2 message. If the target message is estimated to be issued from the target 2 message, the edge extraction unit 122 e process moves to S209. If the target message is not estimated to be issued from the target 2 message, the edge extraction unit 122 process returns to S205 and the edge extraction unit 122 further checks whether or not there is a message issued before.

[S209] If the target message is estimated to be issued from the target 2 message, the edge extraction unit 122 sets the parent node containing the target message to the node containing the target 2 message. More specifically, the edge extraction unit 122 registers the node of the target 2 message in the parent node field corresponding to the node containing the target message of the edge information table 112. Then, the edge extraction unit 122 process moves to S210.

[S210] The edge extraction unit 122 checks whether or not the process of all the messages registered in the node information table 111 has been completed. If the process is determined to be incomplete, the edge extraction unit 122 returns to S202 and repeats the process. If the process is determined to be completed, the edge extraction unit 122 terminates the loop 2 and the process moves to S211.

[S211] The edge extraction unit 122 outputs the generated edge information table 112.

After the above processing procedure is executed, the edge extraction unit 122 may generate the edge information table 112 by analyzing the transitional relationship between the nodes based on the node information table 111.

By analyzing the message history as described above, the Web page transitional relationship may be presented as a tree structure. At this time, the messages for calling the Web page are classified into a node containing the same or similar messages, and then the transitional relationship is analyzed. Therefore, only the messages necessary for calling a specific Web page may be left on the tree structure. If this tree structure is used to generate the Web page reacquisition procedure, the Web page reacquisition procedure optimized only for the request message necessary for calling the specific Web page may be generated. The generated procedure is optimized for a procedure for sending only the necessary messages based on the analysis. The execution of the generated reacquisition procedure allows desired information to be automatically reacquired, thereby simplifying the user operation of reacquiring information.

It should be noted that the above processing functions may be implemented by a computer. In this case, a program coding the processing content of the desired functions of the information reacquisition procedure generation apparatus is provided. By causing a computer to execute the program, the above processing functions are implemented on the computer. The program coding the processing content may be recorded on a computer-readable recording medium.

In order to distribute the program, the program may be stored in a portable recording medium such as a DVD (Digital Versatile Disc) and a CD-ROM (Compact Disc Read Only Memory) and the program may be sold. Alternatively, the program may be stored in a storage device of a server computer, and the program may be transferred to other computers from the server computer through a network.

The computer executing the program stores the program recorded in the portable recording medium or transferred from the server computer in its own storage device. Then, the computer reads the program from its own storage device and executes the process according to the program. Note that the computer may also read the program directly from the portable recording medium to execute the process according to the program. Alternatively, each time the program is transferred from the server computer, the computer may also execute the process according to the received program.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A storage medium recording an information reacquisition procedure generation program causing a computer to execute a process of generating a reacquisition procedure for reacquiring information, the information reacquisition procedure generation program causing the computer to execute a method comprising:
reading a message history from a storage unit storing the message history recording a series of messages exchanged to and from a device providing information until the information is provided;
generating a message transitional relationship with respect to the information by extracting a parent-child relationship between the respective messages contained in the series of messages based on the series of messages until the information contained in the read message history is acquired as well as by combining the same or similar messages of the series of messages into one; and
outputting the reacquisition procedure with respect to the information based on the generated transitional relationship.

2. The storage medium recording an information reacquisition procedure generation program according to claim 1, wherein the transitional relationship is generated by analyzing a syntax of the message recorded in the message history, combining the messages having same or similar specific data contained therein into one and extracting the messages as a node as well as by extracting a parent-child relationship between the nodes as an edge, and a tree structure using the node and the edge is treated as a message transitional relationship with respect to the information.

3. The storage medium recording an information reacquisition procedure generation program according to claim 2, wherein the transitional relationship is generated such that the node extracted is sequentially set to a target node, the messages issued before a target message contained in the target node are sequentially analyzed, an issuer candidate determined as an issuer issuing the target message is retrieved, and a process of setting a node containing the retrieved issuer candidate to a parent node of the target node is repeated to set the parent node to all the extracted nodes.

4. The storage medium recording an information reacquisition procedure generation program according to claim 3, wherein the transitional relationship is generated such that information common to other messages such as a URL, a request method, a response status code, and a response media type contained in the message is extracted as the specific data.

5. The storage medium recording an information reacquisition procedure generation program according to claim 2, wherein the transitional relationship is generated such that, among a plurality of the messages classified in the same node, a message is selected as a representative message; and
as the reacquisition procedure, a procedure for reacquiring the representative message is outputted.

6. The storage medium recording an information reacquisition procedure generation program according to claim 2, wherein the information reacquisition procedure generation program causes the computer to further execute a method comprising:
generating a relation diagram representing the transitional relationship as a tree structure using the node and the edge and presenting the user as well as modifying the transitional relationship and the relation diagram based on a modification instruction when the user enters the modification instruction.

7. The storage medium recording an information reacquisition procedure generation program according to claim 6, wherein the transitional relationship and the relation diagram are modified such that when the node is selected and an instruction for modifying the transitional relationship between the nodes represented by the edge is entered, the parent-child relationship between the nodes including a descendant node with respect to the node selected is modified.

8. The storage medium recording an information reacquisition procedure generation program according to claim 2, wherein the reacquisition procedure is outputted as a reacquisition program causing the computer to execute a series of processes of sequentially following the tree structure starting at a root node thereof until reaching the node containing the message for acquiring target information, generate a request message based on a representative message of the node, and sequentially send the generated request message.

9. The storage medium recording an information reacquisition procedure generation program according to claim 8, wherein the reacquisition procedure is outputted as a reacquisition program causing the computer to execute a series of processes of extracting a response message corresponding to the request message from the message history, extracting specific data from the response message, defining an error process of determining whether or not the specific data is contained in a response from the request message defined by the reacquisition procedure, and executing the error process.

10. An information reacquisition procedure generation apparatus generating a procedure for reacquiring information, comprising:
a storage unit storing a message history recording a series of messages exchanged to and from a device providing specific information until the information is provided;
a reading unit reading the message history from the storage unit;
a transitional relationship generation unit generating a transitional relationship of a message with respect to the information by extracting a parent-child relationship between the respective messages contained in the series of messages based on the series of messages until the information contained in the read message history is acquired as well as by combining the same or similar messages of the series of messages into one; and
a reacquisition procedure output unit outputting a reacquisition procedure with respect to the information based on the generated transitional relationship.
